(19) United States
(12) Patent Application Publication
(10) Pub. No.: US 2014/0244408 A1
(43) Pub. Date: Aug. 28, 2014

(54) SYSTEMS AND METHODS FOR PROVIDING A GESTURE-BASED ELECTRONIC TICKET WHEEL

(71) Applicant: Select Electronics Corporation, Windermere, FL (US)

(72) Inventors: Robert J. Grubel, JR., Rockaway, NJ (US); Michael Petronaci, Windermere, FL (US)

(73) Assignee: Select Electronics Corporation, Windermere, FL (US)

(21) Appl. No.: 14/186,573

(22) Filed: Feb. 21, 2014

Related U.S. Application Data
(60) Provisional application No. 61/767,807, filed on Feb. 22, 2013.

(51) Int. Cl. G06Q 50/12; G06Q 30/06

(52) U.S. Cl. CPC G06Q 50/12; G06Q 30/0633
USPC 705/15

(57) ABSTRACT

The disclosed technology provides an electronic implementation of the functionality of a manual ticket wheel that is capable of receiving orders from a variety of sources in various formats, including point-of-sale systems, cash registers, smart phones, printers, interne requests (e.g., HTTP requests), email, and SMS messages. Users may interact with the electronic ticket wheel of the disclosed technology in the same way that they would a physical ticket wheel (e.g., rotating the wheel, pulling tickets off the wheel, etc.). For example, the computing device implementing the electronic ticket wheel may be a tablet with a touch screen that allows a user to swipe to rotated the wheel and select tickets to remove them from the electronic ticket wheel when the order is complete.

### RELATED APPLICATIONS

This application claims priority to and benefit of, and incorporates herein by reference in its entirety, U.S. Provisional Application No. 61/767,807, filed Feb. 22, 2013.

### BACKGROUND

Traditionally, many restaurant orders are recorded manually on an order ticket or sent to an automatic ticket printer. The order ticket, whether recorded manually or printed, is sent to the restaurant's kitchen and placed in a queue for fulfillment. The queuing mechanism often comprises a wheel-like device which rotates upon a spindle, known as a ticket wheel. Attached to the perimeter of the ticket wheel are spring-loaded clips or other similar means to secure individual order tickets to the ticket wheel.

The ticket wheel is a manually operated device: orders are manually attached, the ticket wheel is manually spun, and orders are manually removed, as appropriate. Orders are typically attached to the ticket wheel at the next available (unused) clip. Once any order is filled, the corresponding order ticket is removed from the ticket wheel, thereby freeing the corresponding clip for attachment of a future order.

The manual ticket wheel has proven to be a very simple but efficient and effective device for use in processing restaurant orders. Nevertheless, as modern available technology has made its way into the restaurant, the continued use of manual ticket wheels has certain drawbacks. The most significant drawback is that the manual ticket wheel does not directly interface to modern, electronic “point-of-sale” systems for restaurants.

Modern point-of-sale systems allow of streamlining the restaurant's operations. These systems allow, among others, many processes to be automated. For example, a customer's order can be automatically generated without any manual input or calculation. In addition, the restaurant's inventory of various food items can be automatically updated after each order. Further, the popularity of menu items can be tracked. Even individual customer's preferences can be easily tracked. In fact, a goal of these point-of-sale systems is to eliminate the need for a written copy of the order ticket.

However, the manual ticket wheel does not lend itself to easy use with such point-of-sale systems. In order to use a manual ticket wheel with an electronic point-of-sale system, there must be produced a written or printed copy of the order ticket. Producing this copy would involve the additional step and of printing on copy of the electronic order ticket. The printed order ticket would be then manually placed upon the ticket wheel, manually spun, and then manually removed, as appropriate. Thus, use of the manual ticket wheel negates much of the potential efficiency advantages inherent in an electronic point-of-sale system for a restaurant.

Attempts to automate the functionality of the manual ticket wheel are often not compatible with many sources of orders, such as point-of-sale machines, cash registers, etc. Thus, the order ticket information must be inputted twice—once for the point-of-sale system, and once for the “ticket wheel” (processing of the order for the customer). This limits the usage of the technology to those with specialized systems.

Moreover, the input often must be made in inflexible, pre-specified formats from limited sources. Typically, manipulating the individual orders on the “ticket wheel” is very crude and often unintuitive. Moreover, routing tickets through the restaurant requires manually moving or reprinting tickets or between only other legacy automated “ticket wheel.”

Thus, there is a need for an electronic ticket wheel that provides an efficient, automated implementation of “ticket wheel” functionality which is compatible with most of the commercially available point-of-sale systems for restaurants and can also process orders received from other sources and in other formats.

### SUMMARY

The disclosed technology provides an electronic implementation of the functionality of a manual ticket wheel that is capable of receiving orders from a variety of sources in various formats, including point-of-sale systems, cash registers, smart phones, printers, internet requests (e.g., HTTP requests), email, and SMS messages. The disclosed technology, in some implementations, includes electronic ticket wheels, implemented on a computing device, such as a smart phone, tablet device, laptop, or other computing device, which include the functionality of a manual ticket wheels. Users may interact with the electronic ticket wheel in the same way that they would a physical ticket wheel (e.g., rotating the wheel, pulling tickets off the wheel, etc.). For example, the computing device implementing the electronic ticket wheel may be a tablet with a touch screen that allows a user to swipe to rotated the wheel and select tickets to remove them from the electronic ticket wheel when the order is complete.

The disclosed technology, in certain embodiments, does not require a pre-defined order record format. Accordingly, an electronic ticket wheel that may receive electronic orders from a variety of sources, including point of sale device, cash registers, smart phones, printers, internet requests (e.g., HTTP requests), email, SMS messages, etc. Users can customize the fields (e.g., information from electronic orders) that are shown and/or hidden on the electronic order tickets displayed on the electronic ticket wheel. Thus, the disclosed technology provides a universal electronic ticket wheel that can be interacted with like a traditional ticket wheel, but can also receive data from a variety of sources without compromising the overall efficiency and streamlining of restaurant operations and management gained by the point-of-sale systems.

The disclosed technology, in certain embodiments, includes a method of providing an electronic ticket wheel for managing orders from customers at a restaurant. In certain embodiments, the method includes receiving, by a processor of a computing device, from a origin system via a wireless communication network, an electronic order, wherein the electronic order comprises one or more menu items associated with an order requested by a consumer, wherein the origin system is at least one of a point-of-sale system, cash register, smart phone, system transmitting internet requests, or system transmitting text messages.

The method may include determining, by the processor, order information based at least in part on the electronic order and a type of the origin system, wherein the order information comprises the one or more menu items. The method may include creating, by the processor, an electronic order ticket that includes the order information.

In certain embodiments, the method includes providing, by the processor, for display on a graphical user interface of the computing device, a graphical representation of a subset of a plurality of electronic order tickets on an electronic ticket wheel, wherein the subset of the plurality of electronic order tickets comprises the electronic order ticket, wherein the graphical user interface of the computing device is configured to display a second subset of the plurality of electronic order tickets in response to a swipe gesture on a touch screen, wherein the second subset of the plurality of electronic order tickets is different than the subset of the plurality of electronic order tickets. The method may include receiving, by the processor, from the touch screen of the computing device, an indication that the order associated with the electronic order ticket is complete, wherein the indication is a removal gesture on the touch screen; and refreshing, by the processor, the graphical user interface of the computing device to remove the electronic order ticket from the subset of the plurality of electronic order tickets provided for display on the graphical user interface of the computing device in response to the removal gesture on the touch screen.

The disclosed technology, in certain embodiments, includes a method of providing an electronic ticket wheel for managing orders from customers at a restaurant. The method may include: (i) receiving, by a processor of a computing device, from an origin system via a wireless communication network, an electronic order, wherein the electronic order comprises one or more menu items associated with an order requested by a consumer, wherein the origin system is at least one of a point-of-sale system, cash register, smart phone, system transmitting internet requests, or system transmitting text messages; (ii) determining, by the processor, order information based at least in part on the electronic order and a type of the origin system, wherein the order information comprises the one or more menu items; (iii) creating, by the processor, an electronic order ticket that includes the order information; (iv) providing, by the processor, for display on a graphical user interface of the computing device, a graphical representation of a subset of a plurality of electronic order tickets on an electronic ticket wheel, wherein the subset of the plurality of electronic order tickets comprises the electronic order ticket, wherein the graphical user interface of the computing device is configured to display a second subset of the plurality of electronic order tickets in response to a gesture on an input device, wherein the second subset of the plurality of electronic order tickets is different than the subset of the plurality of electronic order tickets; (v) receiving, by the processor, from the input device of the computing device, an indication that the order associated with the electronic order ticket is complete, wherein the indication is a removal gesture on the input device; and (vi) refreshing, by the processor, the graphical user interface of the computing device to remove the electronic order ticket from the subset of the plurality of electronic order tickets provided for display on the graphical user interface of the computing device in response to the removal gesture on the input device.

The method may include determining, by the processor, the type of the origin system prior to determining the order information. The method may include archiving, by the processor, the electronic order ticket after receiving the indication that the order associated with the electronic order ticket is complete. In certain embodiments, the method includes receiving, by the processor, a request to recall an archived electronic order ticket; and recalling, by the processor, the archived electronic order ticket.

The method may include communicating, by the processor, a confirmation to the origin system after receiving the indication that the order associated with the electronic order ticket is complete. In certain embodiments refreshing the graphical user interface of the computing device to remove the electronic order ticket includes: refreshing, by the processor, the graphical user interface of the computing device to display a second subset of the plurality of electronic order tickets after receiving the indication that the order associated with the electronic order ticket is complete, wherein the second subset of the plurality of electronic order tickets is different than the subset of the plurality of electronic order tickets and does not include the electronic ticket order.

The plurality of electronic order tickets on the electronic ticket wheel may be displayed in at least one of a sequential order and a preset priority based order. Prior to creating an electronic order ticket that includes the order information, the method may include translating the order information to a different language. The input device may be one or more buttons, one or more wheels, keyboard, keypad, computer mouse, touch screen, and/or touch pad. For example, the input device may be a touch screen and the removal gesture is a swipe of a finger on the touch screen in a specified direction.

The disclosed technology, in certain embodiments, includes a system for providing an electronic ticket wheel for managing orders from customers at a restaurant. The system may include a computing device comprising a processor, and a non-transitory computer readable medium storing instructions thereon, wherein the instructions, when executed, cause the processor to: (i) receive, from an origin system via a wireless communication network, an electronic order, wherein the electronic order comprises one or more menu items associated with an order requested by a consumer, wherein the origin system is at least one of a point-of-sale system, cash register, smart phone, system transmitting internet requests, or system transmitting text messages; (ii) determine order information based at least in part on the electronic order and a type of the origin system, wherein the order information comprises the one or more menu items; (iii) create an electronic order ticket that includes the order information; (iv) provide, for display on a graphical user interface of the computing device, a graphical representation of a subset of a plurality of electronic order tickets on an electronic ticket wheel, wherein the subset of the plurality of electronic order tickets comprises the electronic order ticket, wherein the graphical user interface of the computing device is configured to display a second subset of the plurality of electronic order tickets in response to a gesture on an input device, wherein the second subset of the plurality of electronic order tickets is different than the subset of the plurality of electronic order tickets; (v) receive, from the input device of the computing device, an indication that the order associated with the electronic order ticket is complete, wherein the indication is a removal gesture on the input device; and (vi) refresh the graphical user interface of the computing device to remove the electronic order ticket from the subset of the plurality of electronic order tickets provided for display on the graphical user interface of the computing device in response to the removal gesture on the input device.

### BRIEF DESCRIPTION OF THE FIGURES

The foregoing and other objects, aspects, features, and advantages of the present disclosure will become more apparent and better understood by referring to the following description taken in conjunction with the accompanying drawings, in which:

FIG. 1 is a flowchart of an example method for providing a gesture-based electronic ticket wheel;

FIG. 2 is an illustration of an example graphical user interface providing an electronic ticket wheel;

FIG. 3 is an illustration of an example graphical user interface providing an electronic ticket wheel with several electronic order tickets, including a long electronic order ticket;

FIGS. 4A and 4B are illustrations of an example graphical user interface providing an electronic ticket wheel;

FIG. 5 is an illustration of an example graphical user interface providing an electronic ticket wheel;

FIG. 6 shows a block diagram of an exemplary cloud computing environment; and

FIG. 7 is a block diagram of a computing device and a mobile computing device.

The features and advantages of the present disclosure will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION

The disclosed technology, in some implementations, includes electronic ticket wheels implemented on a computing device, such as a smart phone, tablet device, laptop, or other computing device. Users may interact with the electronic ticket wheel in the same way that they would a physical ticket wheel (e.g., rotating the wheel, pulling tickets off the wheel, etc.). For example, the computing device implementing the electronic ticket wheel may be a tablet with a touch screen that allows a user to swipe to rotate the wheel and select tickets to remove them from the electronic ticket wheel when the order is complete.

The disclosed technology, in some implementations, does not require a pre-defined order record format. An electronic ticket wheel that may receive electronic orders from a variety of sources, including point of sale device, cash registers, smart phones, printers, internet requests (e.g., HTTP requests), email, and SMS messages, without the need to have the order records reformatted to a pre-defined format prior to transmitting them to the electronic ticket wheel system. Thus, the disclosed technology provides a plug-in electronic ticket wheel system that can be interacted with like a traditional ticket wheel, but can also receive order data from a variety of sources.

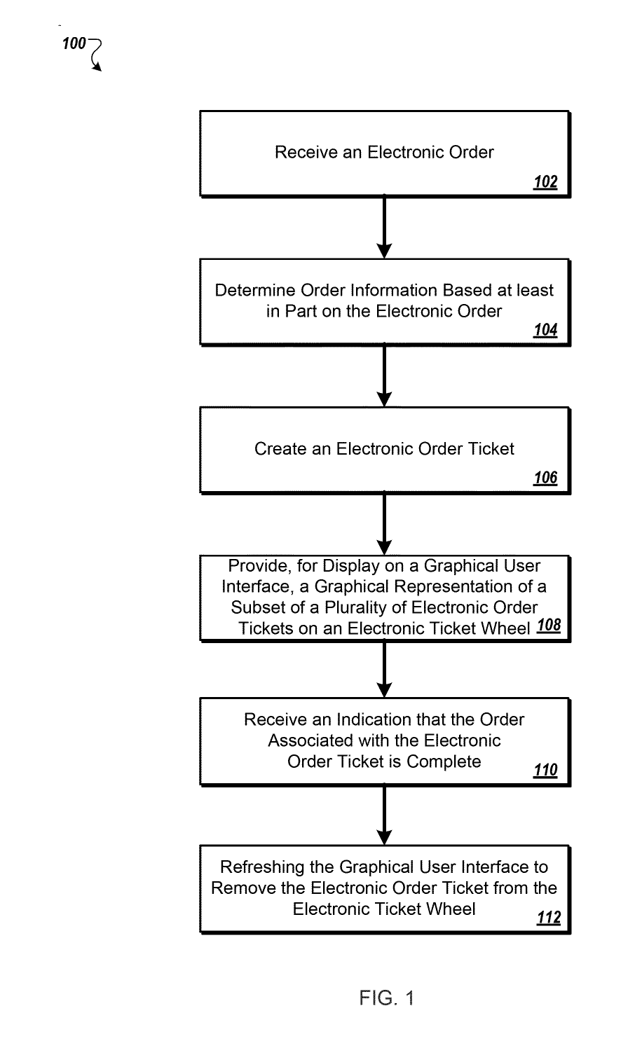

FIG. 1 is an illustration of an example method 100 for implementing a gesture-based electronic ticket wheel. In some implementations, the method 100 includes receiving an electronic order (102). The electronic order is received from an origin system. The electronic order includes an order requested by a customer or a table of customers. For example, the electronic order may include various appetizers and entrees for a dinner party of four.

The origin system may be any number of sources, including point of sale device, cash registers, smart phones, printers, internet requests (e.g., HTTP requests), email, SMS messages, or other data transfer system. An electronic order ticket may be created in any format desired by the restaurant and/or permitted by the origin system. The order ticket is then “printed” (transmitted) to the computing device managing the electronic ticket wheel. The electronic order may be sent from the origin system via a wireless or wired communication network. For example, the order ticket may be transmitted via Bluetooth®, Wifi, wireless data connection, or other wireless communication system.

Moreover, the disclosed technology does not require the tickets sent to the electronic ticket wheel to be in a specific format. The format can automatically be cleaned up, formatted, and displayed without the use of a template. For example, a ticket may have the relevant order data extracted from the ticket regardless of the format. The data can be used for making workflow decisions, providing alerts, and generating operations reports. Moreover, the data can be translated into other languages as required.

The method 100 may include determining order information based at least in part on the electronic order (104), including the menu items on the electronic order. Upon receipt of an order ticket, the computing device may extract the relevant order information from the order ticket. the order information is configured to be used to at least one of: make workflow based decisions, provide alerts, and generate operation reports

The method 100 may include creating an electronic order ticket that includes the order information (106). The process of creating the electronic ticket, in some implementations, is completely automatic. Data within an order ticket may be automatically and/or dynamically recognized and/or characterized. Thus, in some implementations, this eliminates the need for duplicate entry of the order ticket. In some implementations, each order need only be entered once. The “electronic ticket wheel”, in some implementations, allows for formatting order tickets using as desired. For example, the electronic order may be a receipt ticket. The data may be extracted from the receipt ticket and formatted such that an electronic ticket order may be created without a template. In another example, the order information may be translated to a different language prior to creating an electronic order ticket.

The method 100, in some implementations, includes providing, for display on a graphical user interface of the computing device, a graphical representation of a subset of a plurality of electronic order tickets on an electronic ticket wheel (108). For example, ten orders may be in the queue (e.g., the kitchen may need to finish preparing ten orders). The electronic ticket wheel may illustrate a subset (e.g., five) of these ten orders at any given time. When a user rotates (e.g., via swiping the electronic ticket wheel), in some implementations, a different subset of the ten orders are illustrated on the electronic ticket when.

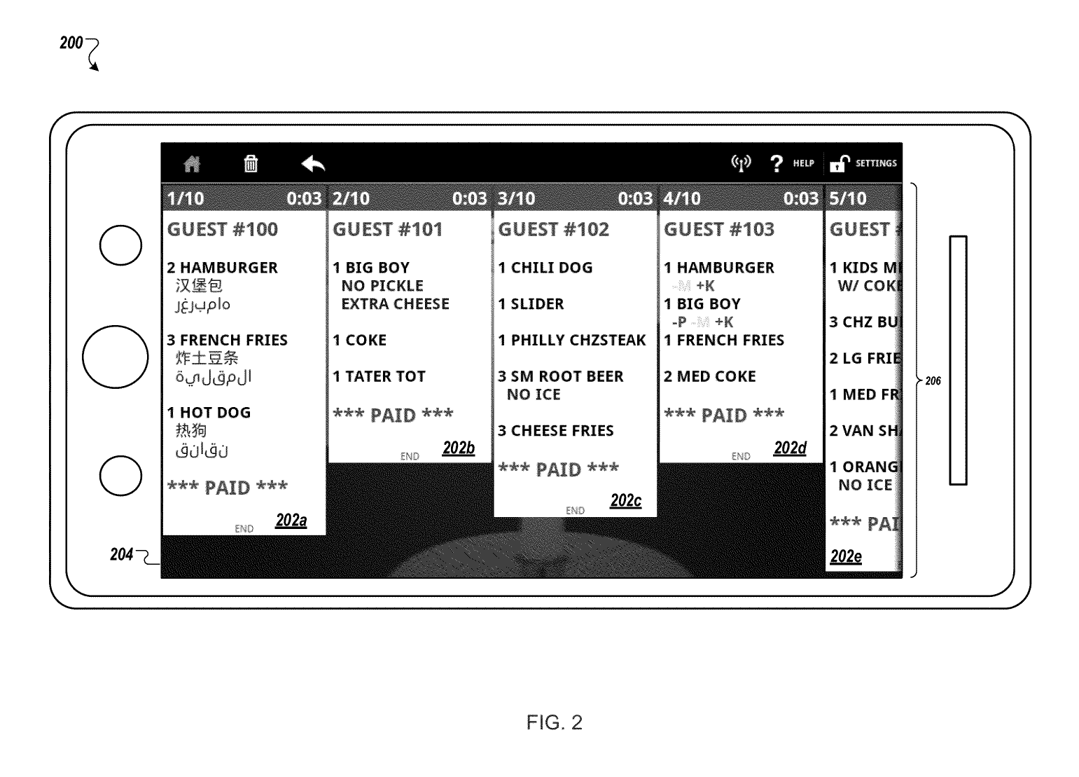

Each created electronic order ticket may be attached (e.g., added) to the electronic ticket wheel. The tickets may be attached sequentially, or according to some preset or dynamic priority system. An example of an electronic ticket wheel is shown in FIG. 2. FIG. 2, as discussed below, illustrates an example graphical user interface implementing an electronic ticket wheel on a computing device, such as a tablet. The computing device may display more than one electronic order ticket at a time. In some implementations, the number of electronic order tickets shown on an electronic ticket wheel may vary depending on the format of the individual electronic order tickets, the size of the computing device screen, and selected system preferences. In some implementations, the format of individual electronic order tickets may be set by a user.

In some implementations, in order to display other order tickets, the electronic ticket wheel is “spun”. In some implementations, the electronic ticket wheel may be spun using gestures on the tablet, such as a swipe gesture. For example, without limitation, a gesture on a touch screen of the computing device of a finger moving to the left may be matched to displaying the ticket wheel “spinning” clockwise, thereby displaying order tickets which are located along the ticket wheel counterclockwise relative to the originally displayed order tickets. Similarly, in some implementations, a gesture on a touch screen of the computing device of a finger moving towards the right may result in displaying the ticket wheel “spinning” counterclockwise, thereby displaying order tickets which are located along the tickets wheel clockwise relative to the originally displayed order tickets. In some implementations, the computing device may have on-screen or physical buttons, wheels, a keyboard, a keypad, touch screen, touch pad, or other mechanisms to allow a user to change the display on the computing device screen to show other order tickets.

In some implementations, the method 100 includes receiving an indication that the order associated with an electronic order ticket is complete (110). Removal may be accomplished, in some implementations, by a designated removal gesture on a touch screen of a computing device, such as a tablet. The removal gesture may be a swipe of a finger on the touch screen in a specified direction. In some implementations, the removal may be initiated by selecting a button or using another type of input device to implement the removal function. In some implementations, order tickets which have been fully processed or are cancelled may be removed from the ticket wheel. In some implementations, once an order ticket is fully processed or canceled, the order ticket is archived. The archived order ticket may be recalled, for example, subsequently, if desired. Archived order tickets may be recalled. Recalled order tickets may be added to the electronic ticket wheel.

The method 100 may include refreshing the graphical user interface of the computing device to remove the completed electronic order ticket (e.g., the electronic order identified in step 110) from the subset of the plurality of electronic order tickets provided for display on the graphical user interface of the computing device (112). For example, the graphical user interface of the computing device may be refreshed to display a second subset of the plurality of electronic order tickets after receiving the indication that the order associated with the electronic order ticket is complete. The second subset of the plurality of electronic order tickets is different than the subset of the plurality of electronic order tickets and does not include the electronic ticket order (e.g., the completed order). Thus, the electronic ticket wheel may be updated when an order is complete such that a new (e.g., different) electronic order ticket is shown on the ticket wheel. This may happen automatically after the order is marked as complete. This allows the electronic ticket wheel to be automatically and continuous populated as new orders are received and/or orders are completed.

Electronic order tickets may be modified, highlighted, moved, removed, or other procedures may be performed on the electronic order tickets using the computing device. In some implementations, only order tickets which have been fully processed or are canceled may be manipulated (removal, modification, highlighted, moved, etc.).

In some implementations, the computing device is a tablet computing device and manipulation is accomplished by designated gestures on the tablet. In some implementations, the gestures may be set by a user such that the user can specify which touch screen gestures accomplish various functions of the electronic ticket wheel system. In some implementations, the computing device may have on-screen or physical buttons, wheels, or other mechanisms to allow interaction with the electronic ticket wheel.

In some implementations, the computing device implementing the electronic ticket wheel communicates with the electronic order origin system after manipulation, archiving, completion, and/or cancellation of an electronic order ticket. For example, this communication may be used to notify a server that an order is ready to be picked up at the kitchen and delivered to a table. The communication may serve as a confirmation that the food was provided to the customers and hence the customers should be charged. For example, the computing device implementing the electronic ticket wheel may communicate a confirmation to the origin system after receiving the indication that the order associated with the electronic order ticket is complete. The communication may be wirelessly or wired communication. For example, the order ticket may be transmitted via Bluetooth®, Wifi, wireless data connection, or other wireless communication system.

FIG. 2 is an illustration of an example graphical user interface providing an electronic ticket wheel on a computing device 200. In some implementations, the display 204 of the computing device 200 illustrates an electronic ticket wheel 206. The ticket wheel 206 includes, for example, electronic order tickets 202a-202e. Users may interact with the electronic ticket wheel 206 in the same way that they would a physical ticket wheel (e.g., rotating the wheel, pulling tickets off the wheel, etc.). For example, the computing device 200 as shown in FIG. 2 is a tablet with a touch screen. In some implementations, the computing device 200 (e.g., a tablet with a touch screen) allows a user to swipe to rotated the wheel and select tickets to remove them from the electronic ticket wheel 206 when the order is complete. Other computing devices and/or input devices may be used as discussed above. For example, the computing device 200 may have on-screen or physical buttons, wheels, touchscreen, touchpad mouse, keyboard, keypad, or other mechanisms to allow a user to interact with an electronic ticket wheel 206.

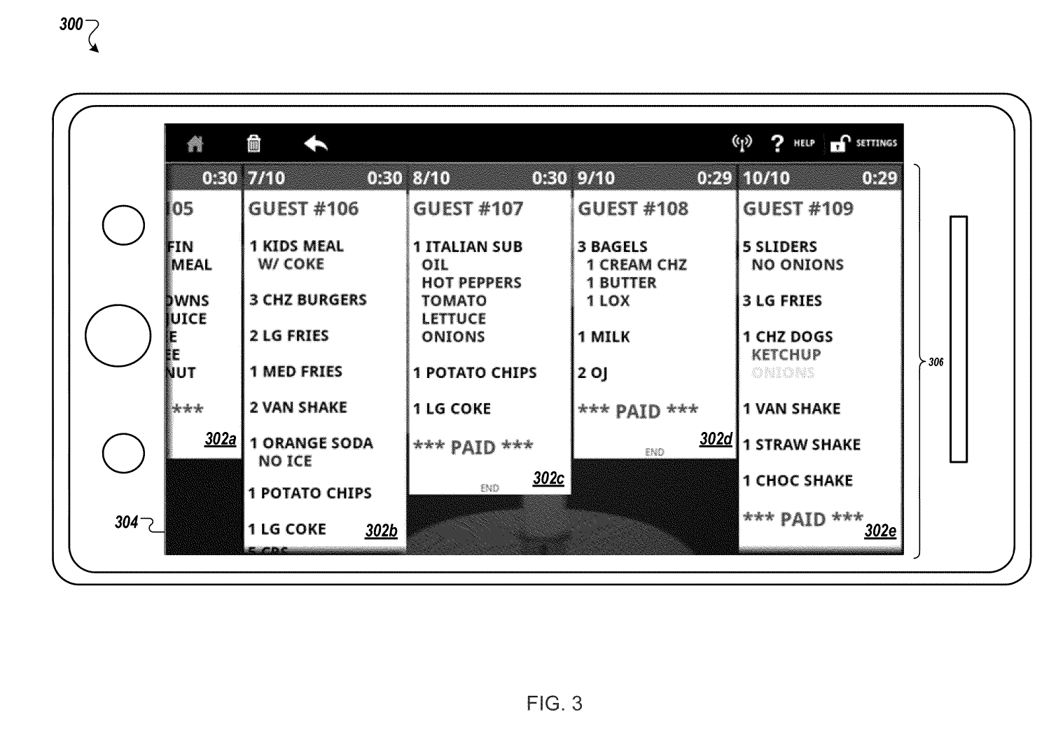

FIG. 3 is an illustration of an example graphical user interface providing an electronic ticket wheel with several electronic order tickets 302a-e, including a long electronic order 302b ticket on a computing device 300. In some implementations, an electronic order ticket 302b may contain many items and may be longer than can be displayed on the display 304. In some implementations, the text of electronic order ticket 302b is resized such that the whole order may be displayed on the screen 304. In some implementations, a user may be able to scroll up and down the order ticket 302b so that they can view the entire order ticket. For example, in some implementations, a user may swipe order ticket 302b up and down to scroll up and down, respectively, so that the user can see every item on the order ticket 302b.

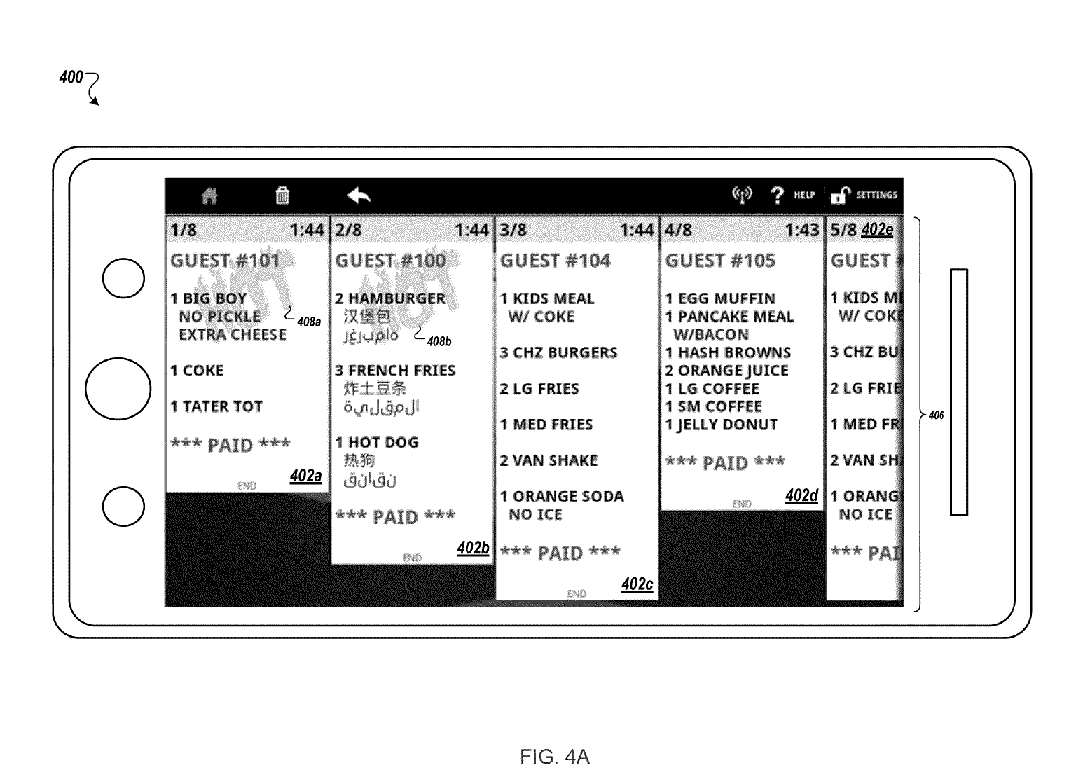

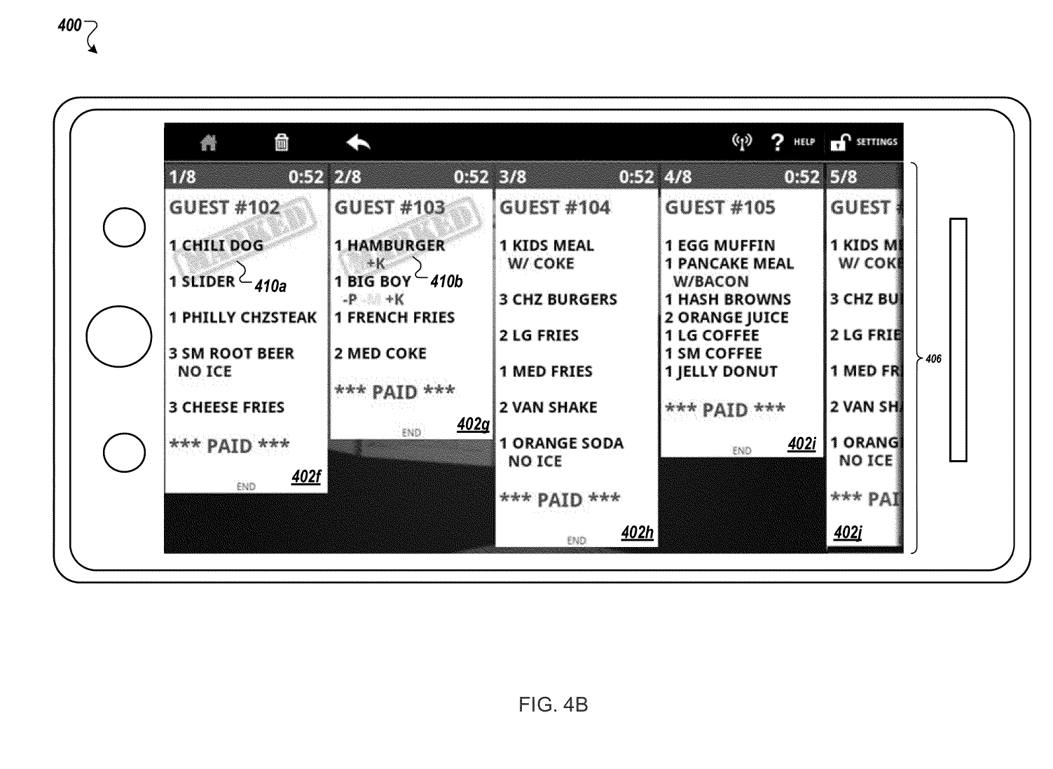

FIGS. 4A and 4B are illustrations of example graphical user interfaces providing an electronic ticket wheel on a computing device 400. The electronic ticket wheel 406 may include several electronic order tickets, such as electronic order tickets 402a-e (as shown in FIG. 4A) or order tickets 402f-j (as shown in FIG. 4B). In some implementations, a user may highlight an electronic order. The user may select to mark an electronic order ticket using an input device, such as a keyboard, touchscreen, touchpad, keypad, mouse, touch screen, or other input device. For example, a gesture on a touchscreen may be associated with the marking function such that when the gesture is performed on an electronic order ticket, the electronic order ticket is marked appropriately (e.g., marked as “hot”). For example, as shown in FIG. 4A, electronic order tickets 402a and 402b have been marked “hot” 408a and 408b respectively. In another example, as shown in FIG. 4B, electronic order tickets 402f and 402g have been marked with the phrase “marked” 410a and 410b, respectively.

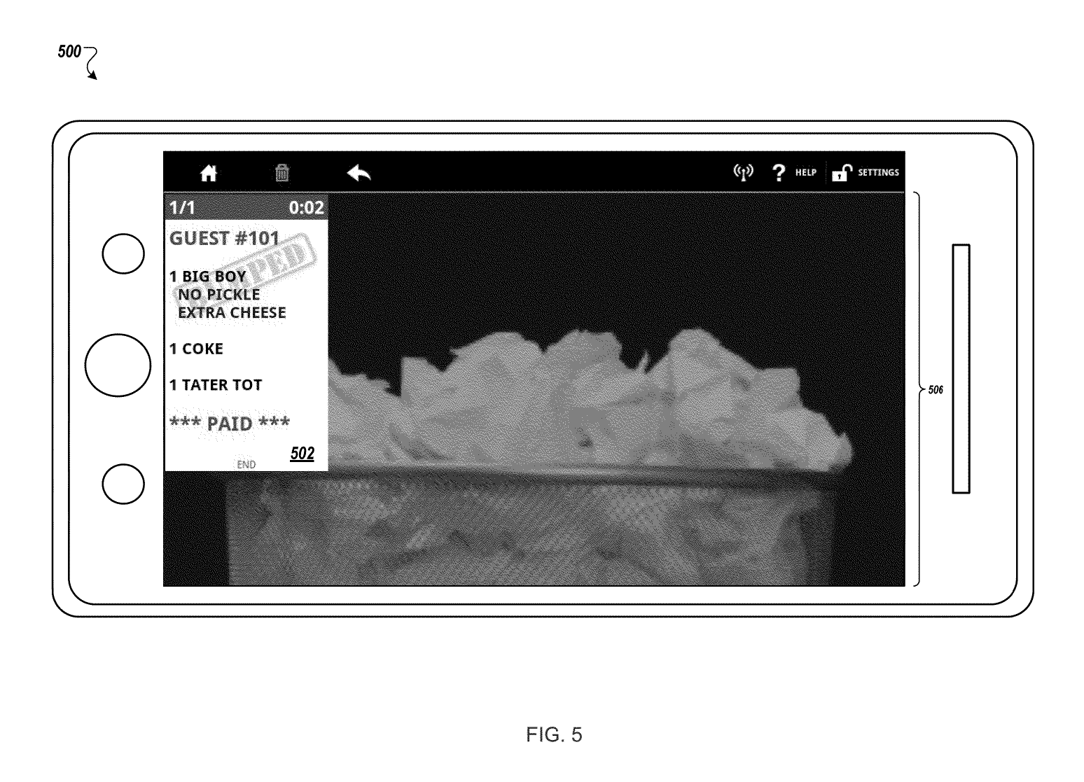

FIG. 5 is an illustration of an example graphical user interface providing an electronic ticket wheel on a computing device 500. In some implementations, the electronic ticket wheel 506 may be used to illustrate electronic order ticket trash bin. In some implementations, deleted electronic order tickets, such as ticket 502 may be placed in an electronic trash bin. The electronic order tickets in the electronic trash bin may be illustrated on an electronic ticket wheel 506 when a user selects to view the electronic trash bin. A user may rotate the electronic ticket wheel 506 as described above and may select to remove electronic order tickets from the electronic trash bin. In some implementations, an electronic ticket wheel is used to show archived electronic order tickets when a user selects to view archived tickets.

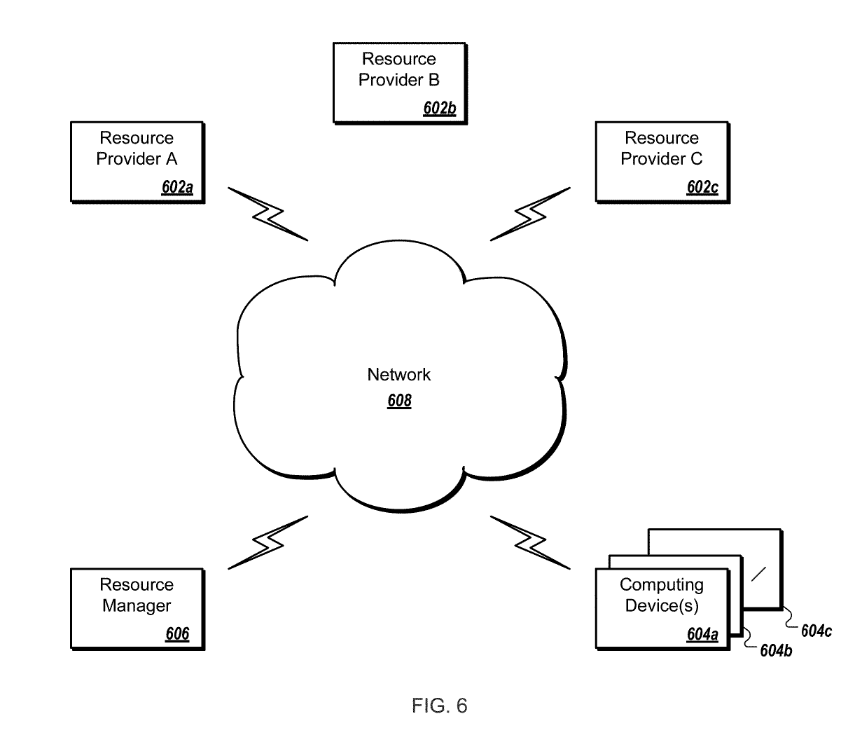

As shown in FIG. 6, an implementation of a network environment 600 for use providing an electronic ticket wheel is shown and described. In brief overview, referring now to FIG. 6, a block diagram of an exemplary cloud computing environment 600 is shown and described. The cloud computing environment 600 may include one or more resource providers 602a, 602b, 602c (collectively, 602). Each resource provider 602 may include computing resources. In some implementations, computing resources may include any hardware and/or software used to process data. For example, computing resources may include hardware and/or software capable of executing algorithms, computer programs, and/or computer applications. In some implementations, exemplary computing resources may include application servers and/or databases with storage and retrieval capabilities. Each resource provider 602 may be connected to any other resource provider 602 in the cloud computing environment 600. In some implementations, the resource providers 602 may be connected over a computer network 608. Each resource provider 602 may be connected to one or more computing device 604a, 604b, 604c (collectively, 604), over the computer network 608.

The cloud computing environment 600 may include a resource manager 606. The resource manager 606 may be connected to the resource providers 602 and the computing devices 604 over the computer network 608. In some implementations, the resource manager 606 may facilitate the provision of computing resources by one or more resource providers 602 to one or more computing devices 604. The resource manager 606 may receive a request for a computing resource from a particular computing device 604. The resource manager 606 may identify one or more resource providers 602 capable of providing the computing resource requested by the computing device 604. The resource manager 606 may select a resource provider 602 to provide the computing resource. The resource manager 606 may facilitate a connection between the resource provider 602 and a particular computing device 604. In some implementations, the resource manager 606 may establish a connection between a particular resource provider 602 and a particular computing device 604. In some implementations, the resource manager 606 may redirect a particular computing device 604 to a particular resource provider 602 with the requested computing resource.

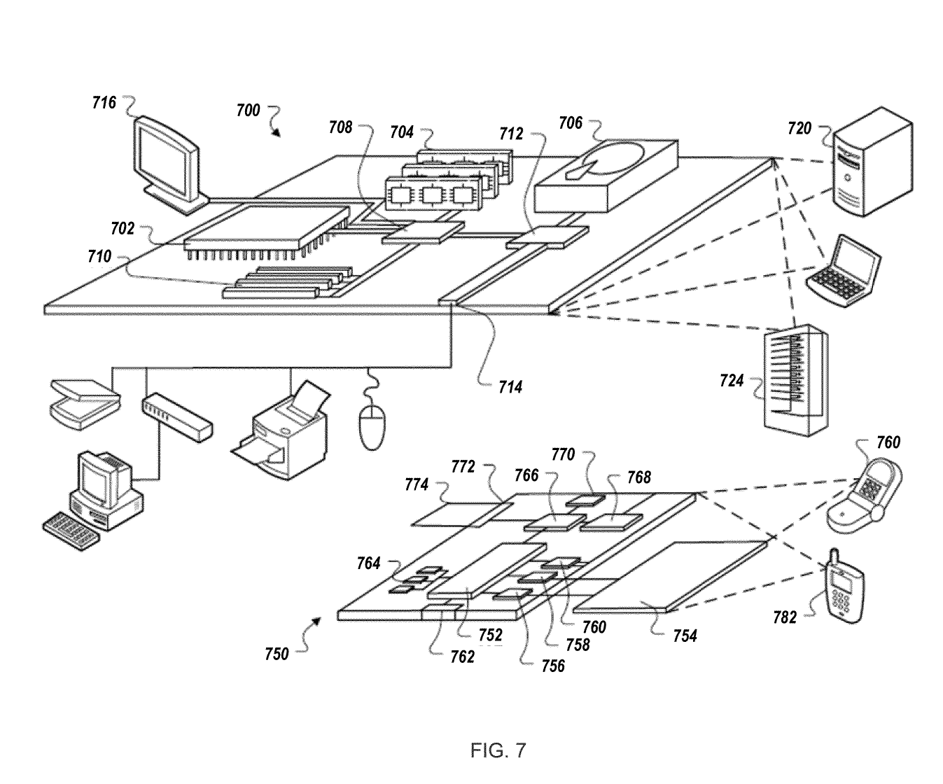

FIG. 7 shows an example of a computing device 700 and a mobile computing device 750 that can be used to implement the techniques described in this disclosure. The computing device 700 is intended to represent various forms of digital computers, such as laptops, desktops, workstations, personal digital assistants, servers, blade servers, mainframes, and other appropriate computers. The mobile computing device 750 is intended to represent various forms of mobile devices, such as personal digital assistants, cellular telephones, smart-phones, and other similar computing devices. The components shown here, their connections and relationships, and their functions, are meant to be examples only, and are not meant to be limiting.

The computing device 700 includes a processor 702, a memory 704, a storage device 706, a high-speed interface 708 connecting to the memory 704 and multiple high-speed expansion ports 710, and a low-speed interface 712 connecting to a low-speed expansion port 714 and the storage device 706. Each of the processor 702, the memory 704, the storage device 706, the high-speed interface 708, the high-speed expansion ports 710, and the low-speed interface 712, are interconnected using various busses, and may be mounted on a common motherboard or in other manners as appropriate. The processor 702 can process instructions for execution within the computing device 700, including instructions stored in the memory 704 or on the storage device 706 to display graphical information for a GUI on an external input/output device, such as a display 716 coupled to the high-speed interface 708. In other implementations, multiple processors and/or multiple buses may be used, as appropriate, along with multiple memories and types of memory. Also, multiple computing devices may be connected, with each device providing portions of the necessary operations (e.g., as a server bank, a group of blade servers, or a multi-processor system).

The memory 704 stores information within the computing device 700. In some implementations, the memory 704 is a volatile memory unit or units. In some implementations, the memory 704 is a non-volatile memory unit or units. The memory 704 may also be another form of computer-readable medium, such as a magnetic or optical disk.

The storage device 706 is capable of providing mass storage for the computing device 700. In some implementations, the storage device 706 may be or contain a computer-readable medium, such as a floppy disk device, a hard disk device, an optical disk device, or a tape device, a flash memory or other similar solid state memory device, or an array of devices, including devices in a storage area network or other configurations. Instructions can be stored in an information carrier. The instructions, when executed by one or more processing devices (for example, processor 702), perform one or more methods, such as those described above. The instructions can also be stored by one or more storage devices such as computer- or machine-readable mediums (for example, the memory 704, the storage device 706, or memory on the processor 702).

The high-speed interface 708 manages bandwidth-intensive operations for the computing device 700, while the low-speed interface 712 manages lower bandwidth-intensive operations. Such allocation of functions is an example only. In some implementations, the high-speed interface 708 is coupled to the memory 704, the display 716 (e.g., through a graphics processor or accelerator), and to the high-speed expansion ports 710, which may accept various expansion cards (not shown). In the implementation, the low-speed interface 712 is coupled to the storage device 706 and the low-speed expansion port 714. The low-speed expansion port 714, which may include various communication ports (e.g., USB, Bluetooth®, Ethernet, wireless Ethernet) may be coupled to one or more input/output devices, such as a keyboard, a pointing device, a scanner, or a networking device such as a switch or router, e.g., through a network adapter.

The computing device 700 may be implemented in a number of different forms, as shown in the figure. For example, it may be implemented as a standard server 720, or multiple times in a group of such servers. In addition, it may be implemented in a personal computer such as a laptop computer 722. It may also be implemented as part of a rack server system 724. Alternatively, components from the computing device 700 may be combined with other components in a mobile device (not shown), such as a mobile computing device 750. Each of such devices may contain one or more of the computing device 700 and the mobile computing device 750, and an entire system may be made up of multiple computing devices communicating with each other.

The mobile computing device 750 includes a processor 752, a memory 764, an input/output device such as a display 754, a communication interface 766, and a transceiver 768, among other components. The mobile computing device 750 may also be provided with a storage device, such as a micro-drive or other device, to provide additional storage. Each of the processor 752, the memory 764, the display 754, the communication interface 766, and the transceiver 768, are interconnected using various buses, and several of the components may be mounted on a common motherboard or in other manners as appropriate.

The processor 752 can execute instructions within the mobile computing device 750, including instructions stored in the memory 764. The processor 752 may be implemented as a chipset of chips that include separate and multiple analog and digital processors. The processor 752 may provide, for example, for coordination of the other components of the mobile computing device 750, such as control of user interfaces, applications run by the mobile computing device 750, and wireless communication by the mobile computing device 750.

The processor 752 may communicate with a user through a control interface 758 and a display interface 756 coupled to the display 754. The display 754 may be, for example, a TFT (Thin-Film-Transistor Liquid Crystal Display) display or an OLED (Organic Light Emitting Diode) display, or other appropriate display technology. The display interface 756 may comprise appropriate circuitry for driving the display 754 to present graphical and other information to a user. The control interface 758 may receive commands from a user and convert them for submission to the processor 752. In addition, an external interface 762 may provide communication with the processor 752, so as to enable near area communication of the mobile computing device 750 with other devices. The external interface 762 may provide, for example, for wired communication in some implementations, or for wireless communication in other implementations, and multiple interfaces may also be used.

The memory 764 stores information within the mobile computing device 750. The memory 764 can be implemented as one or more of a computer-readable medium or media, a volatile memory unit or units, or a non-volatile memory unit or units. An expansion memory 774 may also be provided and connected to the mobile computing device 750 through an expansion interface 772, which may include, for example, a SIMM (Single In Line Memory Module) card interface. The expansion memory 774 may provide extra storage space for the mobile computing device 750, or may also store applications or other information for the mobile computing device 750. Specifically, the expansion memory 774 may include instructions to carry out or supplement the processes described above, and may include secure information also. Thus, for example, the expansion memory 774 may be provide as a security module for the mobile computing device 750, and may be programmed with instructions that permit secure use of the mobile computing device 750. In addition, secure applications may be provided via the SIMM cards, along with additional information, such as placing identifying information on the SIMM card in a non-hackable manner.

The memory may include, for example, flash memory and/or NVRAM memory (non-volatile random access memory), as discussed below. In some implementations, instructions are stored in an information carrier. that the instructions, when executed by one or more processing devices (for example, processor 752), perform one or more methods, such as those described above. The instructions can also be stored by one or more storage devices, such as one or more computer- or machine-readable mediums (for example, the memory 764, the expansion memory 774, or memory on the processor 752). In some implementations, the instructions can be received in a propagated signal, for example, over the transceiver 768 or the external interface 762.

The mobile computing device 750 may communicate wirelessly through the communication interface 766, which may include digital signal processing circuitry where necessary. The communication interface 766 may provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication may occur, for example, through the transceiver 768 using a radio-frequency. In addition, short-range communication may occur, such as using a Bluetooth®, Wi-Fi™, or other such transceiver (not shown). In addition, a GPS (Global Positioning System) receiver module 770 may provide additional navigation- and location-related wireless data to the mobile computing device 750, which may be used as appropriate by applications running on the mobile computing device 750.

The mobile computing device 750 may also communicate audibly using an audio codec 760, which may receive spoken information from a user and convert it to usable digital information. The audio codec 760 may likewise generate audible sound for a user, such as through a speaker, e.g., in a handset of the mobile computing device 750. Such sound may include sound from voice telephone calls, may include recorded sound (e.g., voice messages, music files, etc.) and may also include sound generated by applications operating on the mobile computing device 750.

The mobile computing device 750 may be implemented in a number of different forms, as shown in the figure. For example, it may be implemented as a cellular telephone 780. It may also be implemented as part of a smart-phone 782, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

In view of the structure, functions and apparatus of the systems and methods described here, in some implementations, a system and method for providing an electronic ticket wheel are provided. Having described certain implementations of methods and apparatus for supporting an electronic ticket wheel, it will now become apparent to one of skill in the art that other implementations incorporating the concepts of the disclosure may be used. Therefore, the disclosure should not be limited to certain implementations, but rather should be limited only by the spirit and scope of the following claims.

Throughout the description, where apparatus and systems are described as having, including, or comprising specific components, or where processes and methods are described as having, including, or comprising specific steps, it is contemplated that, additionally, there are apparatus, and systems of the present invention that consist essentially of, or consist of, the recited components, and that there are processes and methods according to the present invention that consist essentially of, or consist of, the recited processing steps.

It should be understood that the order of steps or order for performing certain action is immaterial so long as the invention remains operable. Moreover, two or more steps or actions may be conducted simultaneously.

What is claimed:

1. A method of providing an electronic ticket wheel for managing orders from customers at a restaurant, the method comprising:
receiving, by a processor of a computing device, from a origin system via a wireless communication network, an electronic order, wherein the electronic order comprises one or more menu items associated with an order requested by a consumer, wherein the origin system is at least one of a point-of-sale system, cash register, smart phone, system transmitting internet requests, or system transmitting text messages;
determining, by the processor, order information based at least in part on the electronic order and a type of the origin system, wherein the order information comprises the one or more menu items;
creating, by the processor, an electronic order ticket that includes the order information;
providing, by the processor, for display on a graphical user interface of the computing device, a graphical representation of a subset of a plurality of electronic order tickets on an electronic ticket wheel, wherein the subset of the plurality of electronic order tickets comprises the electronic order ticket, wherein the graphical user interface of the computing device is configured to display a second subset of the plurality of electronic order tickets in response to a swipe gesture on a touch screen, wherein the second subset of the plurality of electronic order tickets is different than the subset of the plurality of electronic order tickets; and
receiving, by the processor, from the touch screen of the computing device, an indication that the order associated with the electronic order ticket is complete, wherein the indication is a removal gesture on the touch screen; and
refreshing, by the processor, the graphical user interface of the computing device to remove the electronic order ticket from the subset of the plurality of electronic order tickets provided for display on the graphical user interface of the computing device in response to the removal gesture on the touch screen.

2. A method of providing an electronic ticket wheel for managing orders from customers at a restaurant, the method comprising:
receiving, by a processor of a computing device, from an origin system via a wireless communication network, an electronic order, wherein the electronic order comprises one or more menu items associated with an order requested by a consumer, wherein the origin system is at least one of a point-of-sale system, cash register, smart phone, system transmitting internet requests, or system transmitting text messages;
determining, by the processor, order information based at least in part on the electronic order and a type of the origin system, wherein the order information comprises the one or more menu items;
creating, by the processor, an electronic order ticket that includes the order information;
providing, by the processor, for display on a graphical user interface of the computing device, a graphical representation of a subset of a plurality of electronic order tickets on an electronic ticket wheel, wherein the subset of the plurality of electronic order tickets comprises the electronic order ticket, wherein the graphical user interface of the computing device is configured to display a second subset of the plurality of electronic order tickets in response to a gesture on an input device, wherein the second subset of the plurality of electronic order tickets is different than the subset of the plurality of electronic order tickets;
receiving, by the processor, from the input device of the computing device, an indication that the order associated with the electronic order ticket is complete, wherein the indication is a removal gesture on the input device; and
refreshing, by the processor, the graphical user interface of the computing device to remove the electronic order ticket from the subset of the plurality of electronic order tickets provided for display on the graphical user interface of the computing device in response to the removal gesture on the input device.

3. The method of claim 2, comprising:
determining, by the processor, the type of the origin system prior to determining the order information.

4. The method of claim 2, comprising:
archiving, by the processor, the electronic order ticket after receiving the indication that the order associated with the electronic order ticket is complete.

5. The method of claim 4, comprising:
receiving, by the processor, a request to recall an archived electronic order ticket; and
recalling, by the processor, the archived electronic order ticket.

6. The method of claim 2, comprising:
communicating, by the processor, a confirmation to the origin system after receiving the indication that the order associated with the electronic order ticket is complete.

7. The method of claim 2, refreshing the graphical user interface of the computing device to remove the electronic order ticket comprises:
refreshing, by the processor, the graphical user interface of the computing device to display a second subset of the plurality of electronic order tickets after receiving the indication that the order associated with the electronic order ticket is complete, wherein the second subset of the plurality of electronic order tickets is different than the subset of the plurality of electronic order tickets and does not include the electronic ticket order.

8. The method of claim 2, wherein the plurality of electronic order tickets on the electronic ticket wheel are displayed in at least one of a sequential order and a preset priority based order.

9. The method of claim 2, comprising:
prior to creating an electronic order ticket that includes the order information, translating the order information to a different language.

10. The method of claim 2, wherein the input device is at least one member selected from the group consisting of: one or more buttons, one or more wheels, keyboard, keypad, computer mouse, touch screen, and touch pad.

11. The method of claim 2, wherein the input device is a touch screen and the removal gesture is a swipe of a finger on the touch screen in a specified direction.

12. A system for providing an electronic ticket wheel for managing orders from customers at a restaurant, the system comprising:
a computing device comprising a processor, and a non-transitory computer readable medium storing instructions thereon, wherein the instructions, when executed, cause the processor to:
receive, from an origin system via a wireless communication network, an electronic order, wherein the electronic order comprises one or more menu items associated with an order requested by a consumer, wherein the origin system is at least one of a point-of-sale system, cash register, smart phone, system transmitting internet requests, or system transmitting text messages;
determine order information based at least in part on the electronic order and a type of the origin system, wherein the order information comprises the one or more menu items;
create an electronic order ticket that includes the order information;
provide, for display on a graphical user interface of the computing device, a graphical representation of a subset of a plurality of electronic order tickets on an electronic ticket wheel, wherein the subset of the plurality of electronic order tickets comprises the electronic order ticket, wherein the graphical user interface of the computing device is configured to display a second subset of the plurality of electronic order tickets in response to a gesture on an input device, wherein the second subset of the plurality of electronic order tickets is different than the subset of the plurality of electronic order tickets;
receive, from the input device of the computing device, an indication that the order associated with the electronic order ticket is complete, wherein the indication is a removal gesture on the input device; and
refresh the graphical user interface of the computing device to remove the electronic order ticket from the subset of the plurality of electronic order tickets provided for display on the graphical user interface of the computing device in response to the removal gesture on the input device.

13. The system of claim 12, wherein the instructions, when executed, cause a processor to:
determine the type of the origin system prior to determining the order information.

14. The system of claim 12, wherein the instructions, when executed, cause a processor to:
archive the electronic order ticket after receiving the indication that the order associated with the electronic order ticket is complete.

15. The system of claim 14, wherein the instructions, when executed, cause a processor to:
receive a request to recall an archived electronic order ticket; and
recall the archived electronic order ticket.

16. The system of claim 12, wherein the instructions, when executed, cause a processor to:
communicate a confirmation to the point-of-sale system after receiving the indication that the order associated with the electronic order ticket is complete.

17. The system of claim 12, wherein refreshing the graphical user interface of the computing device to remove the electronic order ticket comprises:
refresh the graphical user interface of the computing device to display a second subset of the plurality of electronic order tickets after receiving the indication that the order associated with the electronic order ticket is complete, wherein the second subset of the plurality of electronic order tickets is different than the subset of the plurality of electronic order tickets and does not include the electronic ticket order.

18. The system of claim 12, wherein the computing device is selected from the at least one of a smartphone, laptop, desktop, tablet, and mobile computing device.

19. The system of claim 12, wherein the input device is at least one member selected from the group consisting of: one or more buttons, one or more wheels, keyboard, keypad, computer mouse, touch screen, and touch pad.

20. The system of claim 12, wherein the input device is a touch screen and the removal gesture is a swipe of a finger on the touch screen in a specified direction.
